(19) United States
(12) Patent Application Publication
(10) Pub. No.: US 2014/0085225 A1
(43) Pub. Date: Mar. 27, 2014

(54) TOUCH PANEL MODULE AND ELECTRONIC DEVICE THEREWITH

(71) Applicant: WISTRON CORPORATION, New Taipei City (TW)

(72) Inventors: Jui-Kai Cheng, New Taipei City (TW); Wen-Nan Hsia, New Taipei City (TW); Hui-Yuan Peng, New Taipei City (TW)

(73) Assignee: WISTRON CORPORATION, New Taipei City (TW)

(21) Appl. No.: 13/773,655

(22) Filed: Feb. 22, 2013

(30) Foreign Application Priority Data
Sep. 27, 2012 (TW) 101135521

(51) Int. Cl. G06F 3/041

(52) U.S. Cl. CPC G06F 3/0412
USPC 345/173

(57) ABSTRACT

A touch panel module includes a frame, a base plate, a touch material layer, a transmission cable and a first attaching layer. The frame with an opening and a breach connected to the opening formed therein is disposed on a casing. The base plate is disposed on the casing and located inside the opening. The touch material layer is disposed on the base plate, and a peripheral portion of the touch material layer is attached to the frame for sealing the base plate inside the opening. The transmission cable is connected to the touch material layer in a position near the peripheral portion and passes through the casing via the breach. The first attaching layer attaches the frame and the casing for sealing a gap between the frame and the casing, so as to prevent liquids from entering the opening and the breach from the gap.

### BACKGROUND OF THE INVENTION

1. Field of the Invention

The present invention relates to a touch panel module and an electronic device therewith, and more particularly, to a waterproof touch panel module and an electronic device therewith.

2. Description of the Prior Art

Recently, a portable electronic device, such as a mobile phone, a personal digital assistant and so on, has been widely utilized in human's daily life. With development of touch control technology, a touch panel module has been implemented in the portable electronic device and become a trend in the field. Generally speaking, a conventional touch panel module includes a transmission cable disposed through a casing of the portable electronic device for coupling a circuit board of the portable electronic device, such that signals are transmitted between the touch panel module and the circuit board of the portable electronic device.

However, liquids, such as water, coffee and so on, can easily enter the interior of the portable electronic device no matter via a position which the transmission cable passes through the casing of the portable electronic device or via a gap between the touch panel module and the casing of the portable electronic device. It results in damage of internal components of the portable electronic device and causes the product to function abnormally. Thus, how to design a waterproof touch panel module and a portable electronic device therewith becomes an issue in the industry.

### SUMMARY OF THE INVENTION

The present invention provides a waterproof touch panel module and an electronic device therewith for solving above drawbacks.

According to an embodiment of the present invention, a touch panel module includes a frame, a base plate, a touch material layer, a transmission cable and a first attaching layer. The frame is disposed on a casing, and an opening and a breach connected to the opening are formed within the frame. The base plate is disposed on the casing and located inside the opening. The touch material layer is disposed on the base plate, and a peripheral portion of the touch material layer is attached to the frame for sealing the base plate inside the opening. The transmission cable is connected to the touch material layer in a position near the peripheral portion and passes through the casing via the breach. The first attaching layer attaches the frame and the casing for sealing a gap between the frame and the casing, so as to prevent liquids from entering the opening and the breach via the gap between the frame and the casing.

According to another embodiment of the present invention, an electronic device includes a casing and a touch panel module. The touch panel module includes a frame, a base plate, a touch material layer, a transmission cable and a first attaching layer. The frame is disposed on the casing, and an opening and a breach connected to the opening are formed within the frame. The base plate is disposed on the casing and located inside the opening. The touch material layer is disposed on the base plate, and a peripheral portion of the touch material layer is attached to the frame for sealing the base plate inside the opening. The transmission cable is connected to the touch material layer in a position near the peripheral portion and passes through the casing via the breach. The first attaching layer attaches the frame and the casing for sealing a gap between the frame and the casing, so as to prevent liquids from entering the opening and the breach via the gap between the frame and the casing.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electronic device according to an embodiment of the present invention.

FIG. 2 is an exploded diagram of the electronic device according to the embodiment of the present invention.

FIG. 3 is an exploded diagram of the electronic device in another view according to the embodiment of the present invention.

FIG. 4 is a partly sectional diagram of the electronic device according to the embodiment of the present invention.

### DETAILED DESCRIPTION

In the following detailed description of the embodiments, reference is made to the accompanying drawings which form a part hereof, and in which is shown by way of illustration specific embodiments in which the invention may be practiced. In this regard, directional terminology, such as “top,” “bottom,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and “installed” and variations thereof herein are used broadly and encompass direct and indirect connections and installations. Accordingly, the drawings and descriptions will be regarded as illustrative in nature and not as restrictive.

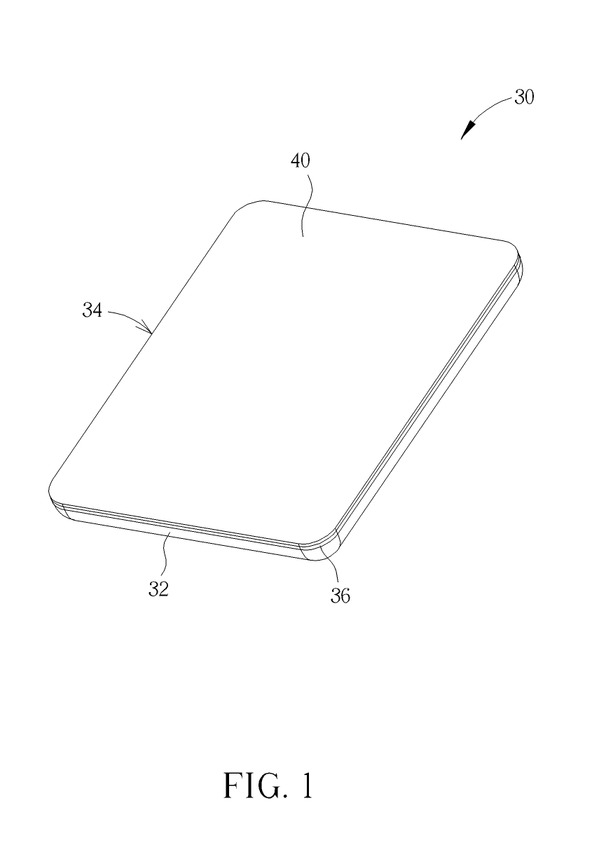

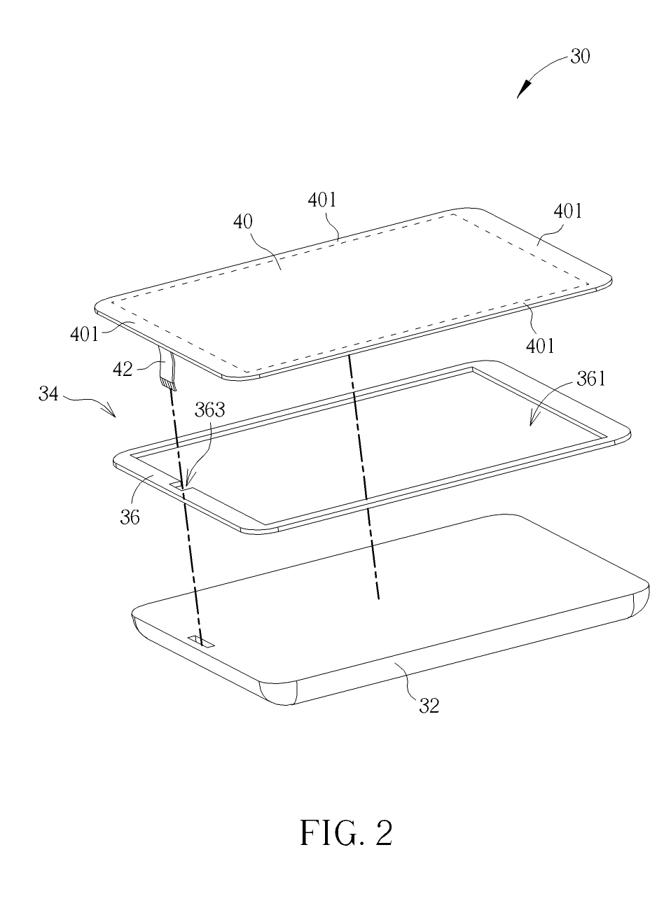

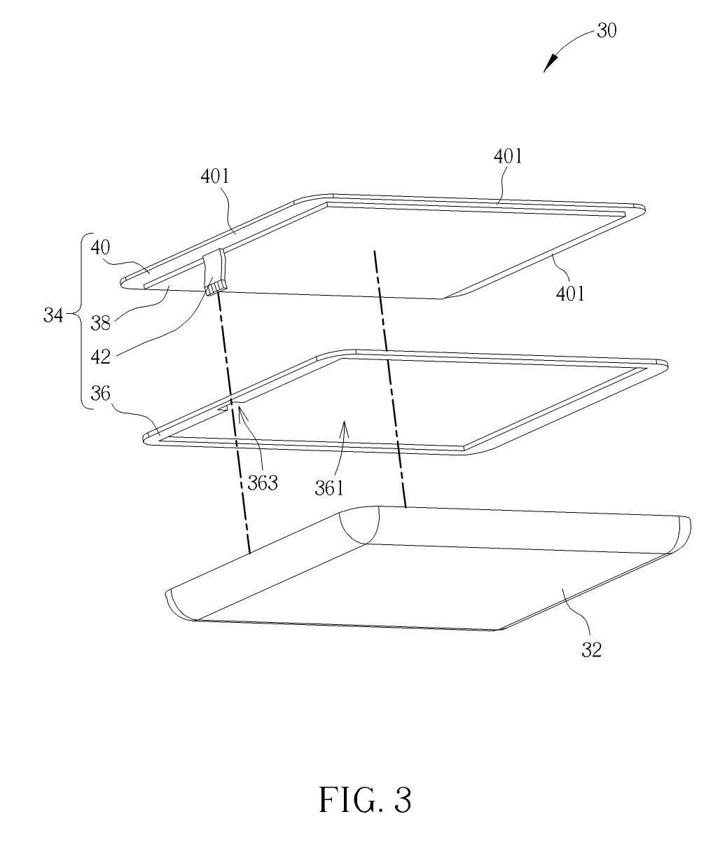

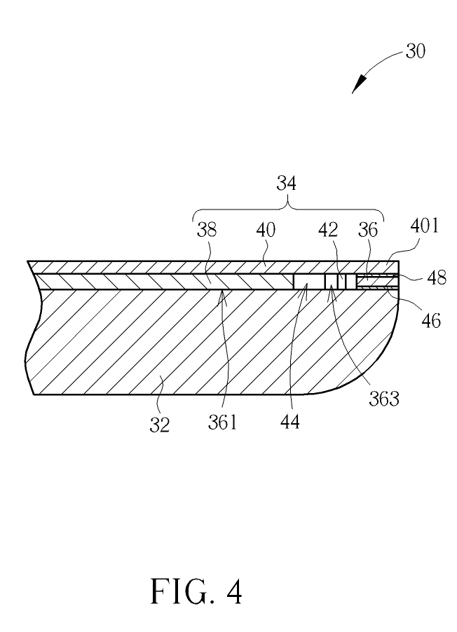

Please refer to FIG. 1 to FIG. 4. FIG. 1 is a schematic diagram of an electronic device 30 according to an embodiment of the present invention. FIG. 2 is an exploded diagram of the electronic device 30 according to the embodiment of the present invention. FIG. 3 is an exploded diagram of the electronic device 30 in another view according to the embodiment of the present invention. FIG. 4 is a partly sectional diagram of the electronic device 30 according to the embodiment of the present invention. As shown in FIG. 1 to FIG. 4, the electronic device 30 includes a casing 32 for covering internal components of the electronic device 30, so as to prevent the internal components of the electronic device 30 from being damaged due to collision. In this embodiment, the electronic device 30 is, but not limited to, a mobile phone or a tablet computer. For example, the electronic device 30 can be a personal digital assistant as well, i.e. implementation of a portable electronic device for the electronic device 30 is within the scope of the present invention.

In addition, the electronic device 30 further includes a touch panel module 34 disposed on the casing 32. The touch panel module 34 provides a user with an operating interface, such that the user can perform touch control operation, such as a page turning, a zooming in and so on, accordingly. Furthermore, the touch panel module 34 includes a frame 36 and a base plate 38. The frame 36 is disposed on the casing 32, and an opening 361 and a breach 363 connected to the opening 361 are formed within the frame 36. The base plate 38 is disposed on the casing 32 and located inside the opening 361 on the frame 36, as shown in FIG. 4. In this embodiment, the frame 36 is made of plastic materials, and the base plate 38 is made of glass materials.

As shown in FIG. 1 to FIG. 4, the touch panel module 34 further includes a touch material layer 40 disposed on the base plate 38. The touch material layer 40 can generate a touch control signal, such that the user can utilize the touch panel module 34 to perform the corresponding touch control operation, such as the page turning, the zooming in and so on. In this embodiment, the touch material layer 40 is, but not limited to, a resistive touch material layer. The touch material layer 40 can be a capacitive touch material layer as well. As for which of the aforesaid designs is adopted, it depends on practical demands.

In addition, a peripheral portion 401 of the touch material layer 40 of the touch panel module 34 is attached to the frame 36, so as to seal the base plate 38 of the touch panel module 34 inside the opening 361 within the frame 36. In this embodiment, a size of the touch material layer 40 is substantially identical to a size of the frame 36 and a size of the casing 32 of the electronic device 30. Accordingly, a periphery of the touch material layer 40 can be aligned with a periphery of the frame 36 and a periphery of the casing 32, as shown in FIG. 4, for enhancing aesthetic feeling of the electronic device 30. In other words, the touch panel module 34 of the electronic device 30 of the present invention can cover a whole top surface of the casing 32, as shown in FIG. 1, for enhancing appearance integrity of the electronic device 30, i.e. the touch panel module 34 of the electronic device 30 is a design with whole planar coverage for covering the whole top surface of the casing 32.

As mentioned above, when the touch panel module 34 of the electronic device 30 is adopted the design with whole planar coverage for covering the whole top surface of the casing 32, the frame 36 can be made of transparent plastic materials for preventing the user from seeing structural body of the frame 36 via the touch panel module 34 with the aforesaid design with whole planar coverage as the electronic device 30 is in use. Accordingly, it can further enhance the appearance integrity and aesthetic feeling of the electronic device 30. The design that the frame 36 is made of transparent materials can be omitted, and it depends on practical demands.

As shown in FIG. 3, the touch panel module 34 further includes a transmission cable 42 connected to the touch material layer 40 in a position near the peripheral portion 401, i.e. the transmission cable 42 is apart from the periphery of the touch material layer 40 by a distance, so as to provide a space for the frame 36 to be attached to the peripheral portion 401 of the touch material layer 40. Furthermore, the transmission cable 42 passes through the casing 32 via the breach 363 on the frame 36, so as to couple with a circuit board, not shown in figures, of the electronic device 30. Accordingly, signals can be transmitted between the touch panel module 34 and the circuit board of the electronic device 30, such that the electronic device 30 can execute the touch control operation performed by the user. In this embodiment, the transmission cable 42 is a Flexible Printed Circuit, FPC.

Since the base plate 38 is made of glass materials and since the glass materials are practically brittle, if a breach is formed on the periphery of the base plate 38 made of glass materials, it will cause the base plate 38 made of glass materials to crack easily due to brittleness and thus reduce a yield rate of the electronic device 30. In the present invention, the breach 363, which allows the transmission cable 42 to pass through the casing 32 and couple with the circuit board of the electronic device 30, is disposed on the frame 36 instead of on the base plate 38 of the touch panel module 34, so as to prevent the aforesaid crack issue resulting from the breach disposed on the base plate 38 made of glass materials, and thus it enhances the yield rate of the electronic device 30.

Furthermore, a containing space 44 is formed between the frame 36 and the base plate 38, and the containing space 44 is used for containing the transmission cable 42, as shown in FIG. 4. In other words, when the transmission cable 42 passes through the casing 32 via the breach 363 within the frame 36, the containing space 44 can increase space the transmission cable 42 being bent. Accordingly, it can avoid the transmission cable 42 from being broken due to insufficient space and thus enhance the yield rate of the electronic device 30.

As shown in FIG. 4, the touch panel module 34 further includes a first attaching layer 46 for attaching the frame 36 and the casing 32 for sealing a gap between the frame 36 and the casing 32, so as to prevent liquids from entering the opening 361 and the breach 363 within the frame 36 via the gap between the frame 36 and the casing 32. In other words, the first attaching layer 46 is capable of preventing the liquids from entering the opening 361 and the breach 363 within the frame 36 via the gap between the frame 36 and the casing 32, so as to further avoid the liquids from entering interior of the electronic device 30, resulting in damage of the internal components, via a position the transmission cable 42 passing through the frame 36.

In addition, the touch panel module 34 further includes a second attaching layer 48 for attaching the frame 36 and the peripheral portion 401 of the touch material layer 40 for sealing a gap between the frame 36 and the peripheral portion 401 of the touch material layer 40, so as to prevent liquids from entering the opening 361 and the breach 363 within the frame 36 via the gap between the frame 36 and the peripheral portion 401 of the touch material layer 40. In other words, the second attaching layer 48 is capable of preventing the liquids from entering the opening 361 and the breach 363 within the frame 36 via the gap between the frame 36 and the peripheral portion 401 of the touch material layer 40, so as to further avoid the liquids from entering interior of the electronic device 30, resulting in damage of the internal components, via a position the transmission cable 42 passing through the frame 36.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel module, comprising:
a frame disposed on a casing, wherein an opening and a breach connected to the opening are formed within the frame;
a base plate disposed on the casing and located inside the opening;
a touch material layer disposed on the base plate, a peripheral portion of the touch material layer being attached to the frame for sealing the base plate inside the opening;
a transmission cable connected to the touch material layer in a position near the peripheral portion and passing through the casing via the breach; and
a first attaching layer attaching the frame and the casing for sealing a gap between the frame and the casing, so as to prevent liquids from entering the opening and the breach via the gap between the frame and the casing.

2. The touch panel module of claim 1, further comprising:
a second attaching layer attaching the frame and the peripheral portion of the touch material layer for sealing a gap between the frame and the peripheral portion of the touch material layer, so as to prevent liquids from entering the opening and the breach via the gap between the frame and the peripheral portion of the touch material layer.

3. The touch panel module of claim 1, wherein a size of the touch material layer is substantially identical to a size of the frame, and a containing space is formed between the frame and the base plate for containing the transmission cable.

4. The touch panel module of claim 1, wherein the frame is made of plastic materials.

5. The touch panel module of claim 4, wherein the frame is made of transparent plastic materials.

6. The touch panel module of claim 1, wherein the base plate is made of glass materials.

7. The touch panel module of claim 1, wherein the touch material layer is a resistive touch material layer or a capacitive touch material layer.

8. An electronic device, comprising:
a casing; and
a touch panel module, comprising:
a frame disposed on the casing, wherein an opening and a breach connected to the opening are formed within the frame;
a base plate disposed on the casing and located inside the opening;
a touch material layer disposed on the base plate, a peripheral portion of the touch material layer being attached to the frame for sealing the base plate inside the opening;
a transmission cable connected to the touch material layer in a position near the peripheral portion and passing through the casing via the breach; and
a first attaching layer attaching the frame and the casing for sealing a gap between the frame and the casing, so as to prevent liquids from entering the opening and the breach via the gap between the frame and the casing.

9. The electronic device of claim 8, wherein the touch panel module further comprises:
a second attaching layer attaching the frame and the peripheral portion of the touch material layer for sealing a gap between the frame and the peripheral portion of the touch material layer, so as to prevent liquids from entering the opening and the breach via the gap between the frame and the peripheral portion of the touch material layer.

10. The electronic device of claim 8, wherein a size of the touch material layer is substantially identical to a size of the frame, and a containing space is formed between the frame and the base plate for containing the transmission cable.

11. The electronic device of claim 8, wherein the frame is made of plastic materials.

12. The electronic device of claim 11, wherein the frame is made of transparent plastic materials.

13. The electronic device of claim 8, wherein the base plate is made of glass materials.

14. The electronic device of claim 8, wherein the touch material layer is a resistive touch material layer or a capacitive touch material layer.
